(19) United States
(12) Patent Application Publication
(10) Pub. No.: US 2023/0194339 A1
(43) Pub. Date: Jun. 22, 2023

(54) RAMAN MICROSCOPE

(71) Applicant: Shimadzu Corporation, Kyoto (JP)

(72) Inventors: Naoya FUJIWARA, Kyoto (JP); Yuka MORITANI, Kyoto (JP)

(73) Assignee: Shimadzu Corporation, Kyoto (JP)

(21) Appl. No.: 17/994,387

(22) Filed: Nov. 28, 2022

(30) Foreign Application Priority Data
Dec. 17, 2021 (JP) 2021-205052

(51) Int. Cl. G01J 3/02; G01J 3/10; G01J 3/44; G01J 3/28

(52) U.S. Cl. CPC G01J 3/0237; G01J 3/108; G01J 3/4412; G01J 3/2823; G01J 2003/106

(57) ABSTRACT

In a Raman microscope, a depth measurement processor performs depth measurement by changing a focal position of laser light along a depth direction of a sample which is an irradiation direction of the laser light with respect to the sample, and meanwhile, acquiring a Raman spectrum of the sample at a plurality of points in the depth direction. A display processor displays an input screen used to input a parameter at a time of performing the depth measurement on the sample in association with a surface image of the sample on a stage. The parameter includes a range in which the focal position of the laser light is changed along the depth direction and an interval between the plurality of points within the range.

### BACKGROUND OF THE INVENTION

### Cross Reference to Related Applications

This application claims priority to Japanese Patent Application No. 2021-205052 filed on Dec. 17, 2021, the entire disclosure of which is incorporated by reference herein.

### FIELD OF THE INVENTION

The present invention relates to a Raman microscope that acquires a Raman spectrum by condensing laser light on a sample on a stage, irradiating the sample with the laser light, and receiving Raman scattered light from the sample by a detector.

### DESCRIPTION OF THE RELATED ART

In a Raman microscope as an example of a Raman spectroscopic instrument, laser light is condensed on a sample on a stage, the sample is irradiated with the laser light, and Raman scattered light from the sample is received by a detector (see, for example, JPH10-90064).

### SUMMARY OF THE INVENTION

In the Raman microscope as described above, a Raman spectrum at a plurality of points in a depth direction of the sample can be acquired by changing a focal position of the laser light along the depth direction which is the irradiation direction of the laser light with respect to the sample. In this case, because a user needs to perform an operation such as changing the height of the stage, the operation is complicated.

The present invention has been made in view of the above circumstances, and the present invention provides a Raman microscope that can easily acquire Raman spectra at a plurality of points in the depth direction.

A first aspect of the present invention is a Raman microscope that acquires a Raman spectrum from a sample on a stage by condensing laser light, irradiating the sample with laser light, and receiving Raman scattered light from the sample by a detector, the Raman microscope including a depth measurement processor and a display processor. The depth measurement processor performs depth measurement by changing a focal position of the laser light along the depth direction of the sample which is an irradiation direction of the laser light with respect to the sample, and meanwhile, acquiring the Raman spectrum of the sample at a plurality of points in the depth direction. The display processor displays an input screen used to input a parameter at the time of performing the depth measurement on the sample in association with a surface image of the sample on the stage. The parameter includes a range in which the focal position of the laser light is changed along the depth direction and an interval between the plurality of points within the range.

According to the present invention, the Raman spectrum at the plurality of points in the depth direction can be easily acquired.

### BRIEF DESCRIPTION OF THE DRAWINGS

FIG. 1 is a schematic view showing a configuration example of a Raman microscope;

FIG. 2 is a schematic view showing a configuration example of the Raman microscope;

FIG. 3 is a block diagram showing an example of an electrical configuration of the Raman microscope;

FIG. 4 is a view showing an example of an operation screen displayed on a display unit;

FIG. 5 is a view showing an example of the operation screen displayed on the display unit; and

FIG. 6 is a view showing an example of the operation screen displayed on the display unit.

### DETAILED DESCRIPTION OF THE PREFERRED EMBODIMENTS

### 1. Overall Configuration of Raman Microscope

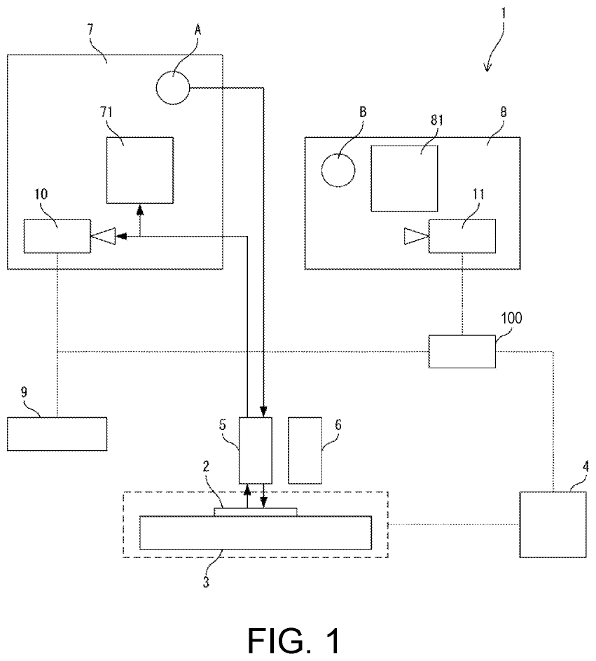

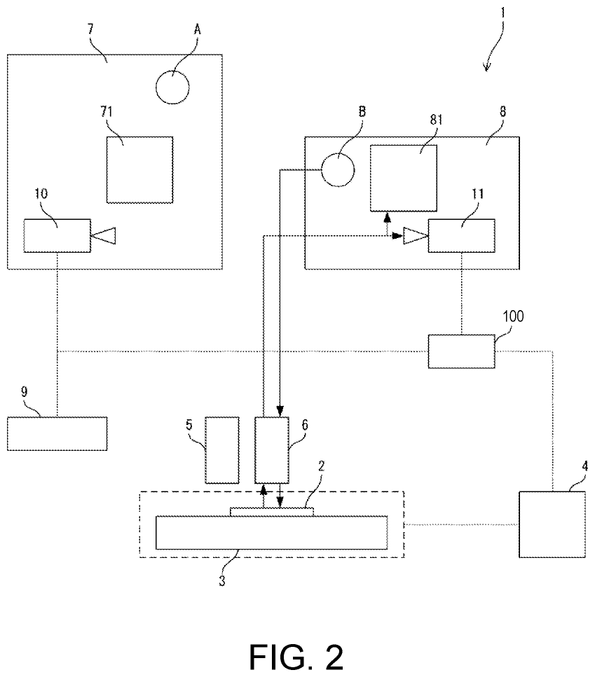

FIGS. 1 and 2 are schematic views each showing a configuration example of a Raman microscope 1. The Raman microscope 1 according to the present embodiment can perform not only Raman spectroscopic analysis but also infrared spectroscopic analysis. FIG. 1 shows a state when the Raman spectroscopic analysis is performed, and FIG. 2 shows a state when the infrared spectroscopic analysis is performed.

The Raman microscope 1 includes a plate 2, a stage 3, a drive unit 4, an objective optical element 5, an objective optical element 6, a Raman light detection system 7, an infrared light detection system 8, a switching mechanism 9, and others. A sample is placed on the stage 3 while being fixed to the plate 2. The stage 3 can be displaced in the horizontal direction or the vertical direction by driving of the drive unit 4. The drive unit 4 includes, for example, a motor and a gear.

The objective optical element 5 is used for the Raman spectroscopic analysis, and has, for example, a configuration in which a convex lens and a concave lens are combined. At the time of performing the Raman spectroscopic analysis, the objective optical element 5 faces the sample on the plate 2 as shown in FIG. 1. That is, the objective optical element 5 is located immediately above the sample on the plate 2.

The objective optical element 6 is used for the infrared spectroscopic analysis, and is, for example, a Cassegrain mirror that has a configuration in which a convex mirror and a concave mirror are combined. At the time of performing the infrared spectroscopic analysis, the objective optical element 6 faces the sample on the plate 2 as shown in FIG. 2. That is, the objective optical element 6 is located immediately above the sample on the plate 2.

The Raman light detection system 7 is used for performing the Raman spectroscopic analysis, and includes a light source A, an optical imaging element 10, and a Raman spectrometer 71. Light emitted from the light source A is, for example, laser light having a wavelength in the visible range or the near-infrared range, and the wavelength thereof is about several micrometers to several tens of micrometers. As shown in FIG. 1 at the time of performing the Raman spectroscopic analysis, the light emitted from the light source A is guided to the objective optical element 5 by various optical elements (not shown).

The light incident on the objective optical element 5 is focused on the sample fixed to the plate 2. That is, the light from the light source A is condensed by being transmitted through the objective optical element 5, and is applied to the focal position on the sample or in the sample. Raman scattered light is generated from the sample irradiated with the light from the light source A, and this light is guided to the Raman light detection system 7 by various optical elements (not shown). A part of the light guided from the objective optical element 5 to the Raman light detection system 7 is incident on the optical imaging element 10, and the remaining light is incident on the Raman spectrometer 71.

The optical imaging element 10 captures a visible image of the sample surface on which the Raman scattered light is generated. The optical imaging element 10 includes, for example, a charge coupled device (CCD) image sensor or a complementary metal oxide semiconductor (CMOS) image sensor, and is configured to be able to capture a still image or a moving image of the sample. The optical imaging element 10 can capture all or at least one of a bright field image, a dark field image, a phase difference image, a fluorescence image, a polarization microscope image, and others of the sample.

The Raman spectrometer 71 detects the intensity for each wavelength by dispersing the Raman scattered light from the sample. Based on a detection signal from the Raman spectrometer 71, a Raman spectrum can be acquired. In the Raman spectrum, the vertical axis represents the intensity, and the horizontal axis represents the wavelength. As described above, in the Raman microscope 1, the Raman spectrum can be acquired by receiving the Raman scattered light from the sample by the detector (the Raman spectrometer 71).

The infrared light detection system 8 is used for performing the infrared spectroscopic analysis, and includes a light source B, an optical imaging element 11, and an infrared spectrometer 81. Light emitted from the light source B is, for example, infrared light emitted from a ceramic heater, and has a wavelength of about 405 nm to 1064 nm, and in many cases, light obtained by combining wavelengths of 532 nm and 785 nm is used. As shown in FIG. 2, at the time of performing the infrared spectroscopic analysis, the light emitted from the light source B is guided to the objective optical element 6 by various optical elements (not shown).

The light incident on the objective optical element 6 is focused on the sample fixed to the plate 2. That is, the light from the light source B is condensed by being transmitted through the objective optical element 6, and is applied to the focal position on the sample or in the sample. Reflected light from the sample irradiated with the light from the light source B is guided to the infrared light detection system 8 by various optical elements (not shown). A part of the light guided from the objective optical element 6 to the infrared light detection system 8 is incident on the optical imaging element 11, and the remaining light is incident on the infrared spectrometer 81.

The optical imaging element 11 captures a visible image of the sample surface on which the infrared light is reflected. The optical imaging element 11 may have a configuration similar to that of the optical imaging element 10. Similarly to the optical imaging element 10, the optical imaging element 11 can capture a still image or a moving image of the sample, and can capture all or at least one of a bright field image, a dark field image, a phase difference image, a fluorescence image, a polarization microscope image, and others of the sample.

The infrared spectrometer 81 is, for example, a Fourier transform infrared spectrometer. The spectrometer included in the infrared spectrometer 81 may be a Michelson interferometer spectrometer. The infrared spectrometer 81 detects the intensity for each wavelength by dispersing the infrared reflected light from the sample. Based on a detection signal from the infrared spectrometer 81, an infrared spectrum can be acquired. In the infrared spectrum, the vertical axis represents the intensity, and the horizontal axis represents the wavelength. As described above, in the Raman microscope 1, the infrared spectrum can be acquired by receiving the infrared reflected light from the sample by the detector (the infrared spectrometer 81).

The switching mechanism 9 switches between the Raman spectroscopic analysis and the infrared spectroscopic analysis. Specifically, the switching mechanism 9 drives the stage 3 by the drive unit 4 to adjust the positional relationship between the objective optical element 5 and the plate 2 and the positional relationship between the objective optical element 6 and the plate 2. In the case of switching to the Raman spectroscopic analysis, the positional relationship between the objective optical element 5 and the plate 2 is adjusted, so that the focal position of the light collected by the objective optical element 5 is adjusted to a predetermined measurement position in the sample. On the other hand, in the case of switching to the infrared spectroscopic analysis, the positional relationship between the objective optical element 6 and the plate 2 is adjusted, so that the focal position of the light collected by the objective optical element 6 is adjusted to a predetermined measurement position in the sample.

### 2. Electrical Configuration of Raman Microscope

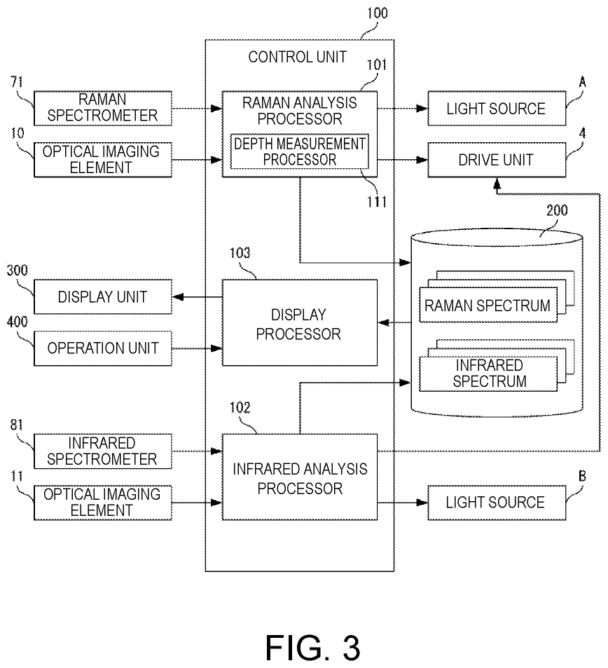

FIG. 3 is a block diagram showing an example of an electrical configuration of the Raman microscope 1. In addition to the constituents described above, the Raman microscope 1 includes a control unit 100, a storage unit 200, a display unit 300, and an operation unit 400.

The control unit 100 includes, for example, a central processing unit (CPU). The control unit 100 functions as a Raman analysis processor 101, an infrared analysis processor 102, a display processor 103, and the like by the CPU executing a program.

The Raman analysis processor 101 executes processing for performing the Raman spectroscopic analysis on the sample on the stage 3 in a state of being switched to the Raman spectroscopic analysis by the switching mechanism 9. That is, the sample is irradiated with laser light condensed from the light source A, and the Raman spectrum is acquired based on the detection signal from the Raman spectrometer 71. In addition, the Raman analysis processor 101 can acquire a surface image of the sample during the Raman spectroscopic analysis on the basis of the visible image captured by the optical imaging element 10. At the time of the Raman spectroscopic analysis, analysis may be performed while the stage 3 is moved by controlling the drive unit 4.

The infrared analysis processor 102 executes processing for performing the infrared spectroscopic analysis on the sample on the stage 3 in a state of being switched to the infrared spectroscopic analysis by the switching mechanism 9. That is, the sample is irradiated with infrared light condensed from the light source B, and the infrared spectrum is acquired based on the detection signal from the infrared spectrometer 81. In addition, the infrared analysis processor 102 can acquire the surface image of the sample during the infrared spectroscopic analysis on the basis of the visible image captured by the optical imaging element 11. At the time of the infrared spectroscopic analysis, analysis may be performed while the stage 3 is moved by controlling the drive unit 4.

Data during the Raman spectroscopic analysis obtained by processing of the Raman analysis processor 101 and data during the infrared spectroscopic analysis obtained by processing of the infrared analysis processor 102 are stored in the storage unit 200. The storage unit 200 includes, for example, a nonvolatile memory such as a hard disk. The storage unit 200 stores, for example, the Raman spectrum acquired by the Raman spectroscopic analysis and the infrared spectrum acquired by the infrared spectroscopic analysis.

The display processor 103 controls display on the display unit 300. That is, under the control of the display processor 103, various screens such as an operation screen are displayed on a display screen of the display unit 300. The display unit 300 includes, for example, a liquid crystal display, but is not limited thereto. The Raman spectrum or the infrared spectrum stored in the storage unit 200 can be displayed on the display screen of the display unit 300 under the control of the display processor 103.

The operation unit 400 is provided for a user to perform an input operation, and includes, for example, a keyboard or a mouse, but is not limited thereto. When the operation screen is displayed on the display unit 300, the input operation on the operation screen can be performed by operating the operation unit 400. When the input operation is performed using the operation unit 400, input information (such as a numerical value) is reflected and displayed on the operation screen of the display unit 300.

In the present embodiment, the Raman analysis processor 101 includes a depth measurement processor 111. The depth measurement processor 111 controls the drive unit 4 during the Raman spectroscopic analysis to acquire Raman spectra at a plurality of points while moving the stage 3 in the vertical direction, thereby performing depth measurement. That is, at the time of depth measurement, the distance between the sample and the objective optical element 5 changes as the stage 3 moves in the vertical direction.

Because the focal position of the laser light from the objective optical element 5 toward the sample is constant, the focal position of the laser light with respect to the sample changes with the movement of the stage 3 at the time of depth measurement. That is, the focal position of the laser light with which the sample is irradiated at the time of depth measurement is not only on the sample but also inside the sample.

Specifically, in the depth measurement, the focal position of the laser light is changed along the depth direction which is the irradiation direction (optical axis direction) of the laser light with respect to the sample, and meanwhile, the Raman spectrum is acquired based on the detection signals detected at a predetermined interval from the Raman spectrometer 71. As a result, the Raman spectrum based on the detection signal from the Raman spectrometer 71 is acquired at each of the plurality of points separated at the predetermined interval in the depth direction. The predetermined interval can be set in advance by the user.

The display processor 103 can cause the display unit 300 to display an input screen for inputting parameters for performing the depth measurement. The parameter includes, in addition to the predetermined interval, a range in the depth direction in which the depth measurement is performed, a diameter (spot diameter) of the laser light on the surface image of the sample, and others. The depth measurement processor 111 performs the depth measurement on the basis of the parameters input to the input screen.

### 3. Specific Example of Operation Screen

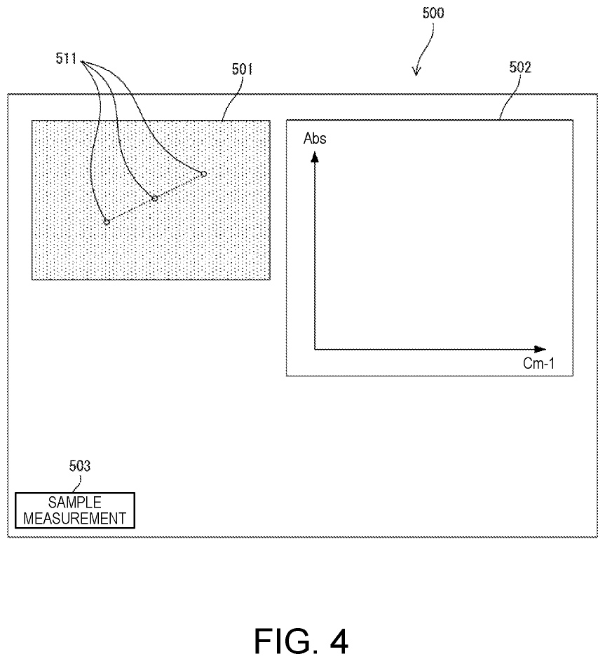

FIGS. 4 to 6 are views each showing an example of an operation screen 500 displayed on the display unit 300. The operation screen 500 includes a surface image display region 501 and a spectrum display region 502. However, both the surface image display region 501 and the spectrum display region 502 are not limited to a display mode included in the operation screen 500, and at least one of the above may be displayed on a screen different from the operation screen 500.

The surface image of the sample on the stage 3 is displayed in the surface image display region 501. That is, the visible image captured by the optical imaging element 10 is displayed in the surface image display region 501. The surface image of the sample displayed in the surface image display region 501 may be a real-time image captured by the optical imaging element 10 or a still image captured at a predetermined timing. When the stage 3 is moved in the horizontal direction (direction intersecting the depth direction), a region of the surface image of the sample displayed in the surface image display region 501 may be changed.

The user can select a measurement position on the surface image of the sample displayed in the surface image display region 501. The measurement position is an optional position selected in the horizontal plane, and the depth measurement is performed along the depth direction at the selected measurement position.

Only one measurement position may be selected, or a plurality of measurement positions may be selected. In the example of FIG. 4, three measurement positions 511 are selected. The plurality of measurement positions 511 are selected so as to be aligned on a straight line. The measurement position 511 is selected by an operation on the operation unit 400, but any method can be used for selecting the measurement position 511. For example, in a case where the operation unit 400 includes a pointing device such as a mouse, the plurality of measurement positions 511 can be easily selected by a drag operation or the like. The distance between the plurality of measurement positions 511 in the horizontal direction may be constant or may not be constant.

The light source A in the Raman light detection system 7 may be able to emit laser light at a plurality of wavelengths. In this case, the measurement position selected on the surface image of the sample displayed in the surface image display region 501 may be selectable for each wavelength.

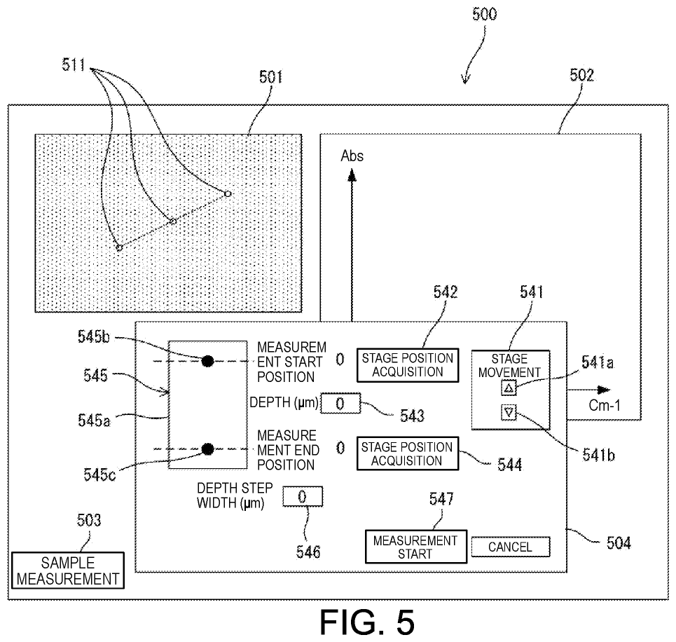

After selecting the measurement position 511 as described above, the user selects a sample measurement key 503. The sample measurement key 503 is a selection key to cause the input screen for inputting parameters for performing the depth measurement to be displayed. When the sample measurement key 503 is selected, an input screen 504 is displayed on the display unit 300 as shown in FIG. 5.

In this example, the input screen 504 is popped up on the display unit 300 as a screen different from the operation screen 500. As a result, because the surface image display region 501 and the input screen 504 are simultaneously displayed on the display unit 300, the input screen 504 can be displayed in association with the surface image of the sample. However, the present invention is not limited to this configuration, and the input screen 504 may be displayed as an input region in the operation screen 500.

In the input screen 504, parameters for the depth measurement include a range (depth range) in which the focal position of the laser light is changed along the depth direction, and an interval (step width) between the plurality of points at which the Raman spectrum is acquired in the depth range. The depth range can be defined by the upper end and the lower end in the depth direction. The step width may be a constant interval or may not be a constant interval between the plurality of points.

The input screen 504 includes a focus operation region 541 operated to move the stage 3 in the depth direction. The focus operation region 541 includes, for example, an upward movement key 541a operated to move the stage 3 upward along the depth direction and a downward movement key 541b operated to move the stage 3 downward along the depth direction. The user can change the focal position of the laser light with respect to the sample along the depth direction by moving the stage 3 upward or downward in the depth direction by operating the focus operation region 541.

The input screen 504 includes an upper end setting region 542 operated to set the upper end of the depth range. After adjusting the focal position by performing an operation on the focus operation region 541 as described above, the user can set the focal position at that time to the upper end of the depth range by selecting the upper end setting region 542. That is, by selecting the upper end setting region 542, the focal position changed by the operation on the focus operation region 541 is set as the upper end of the depth range.

The upper end of the depth range may be the surface (upper surface) of the sample or a position shifted in the depth direction with respect to the surface of the sample. In the case of setting the surface of the sample to the upper end of the depth range, the focus operation region 541 may be operated such that the spot diameter becomes the smallest on the surface image of the sample displayed in real time in the surface image display region 501, and then the upper end setting region 542 may be selected. However, instead of viewing the surface image of the sample displayed in the surface image display region 501, the user may operate the focus operation region 541 such that the spot diameter becomes the smallest while directly viewing the surface of the sample. Meanwhile, if the upper end of the depth range is set above the surface of the sample, the depth measurement can be started from above the surface of the sample.

The input screen 504 includes a depth input region 543 used for inputting a depth with reference to the upper end of the depth range set by selecting the upper end setting region 542. A numerical value representing the depth can be input to the depth input region 543. Because the depth with respect to the upper end of the depth range set in the upper end setting region 542 is input by the input operation to the depth input region 543, the lower end of the depth range is set, and accordingly, the setting of the depth range is completed.

In the present embodiment, in addition to the depth range setting method as described above, the depth range can also be set by an operation on a lower end setting region 544 included in the input screen 504. In this case, after setting the upper end of the depth range by selecting the upper end setting region 542, the user performs operation on the focus operation region 541 to adjust the focal position to a desired position as the lower end of the depth range. Thereafter, by selecting the lower end setting region 544, the focal position changed by the operation on the focus operation region 541 is set as the lower end of the depth range, and the setting of the depth range is completed.

The input screen 504 includes a symbol display region 545 that displays symbols representing the relative positional relationship between the upper end and the lower end of the depth range. In the symbol display region 545, a symbol 545a representing the sample is virtually displayed, and a symbol 545b representing the upper end and a symbol 545c representing the lower end of the depth range are displayed with the symbol 545a as a reference.

The position of the symbol 545c representing the lower end of the depth range changes according to the depth input to the depth input region 543. Therefore, the position of the lower end of the depth range can be displayed to the user in an easy-to-understand manner. Note that the position of the symbol 545b representing the upper end of the depth range may change according to the operation on the focus operation region 541 before the upper end setting region 542 is selected. In addition, the position of the symbol 545c representing the lower end of the depth range may change according to the operation on the focus operation region 541 before the lower end setting region 544 is selected.

The input screen 504 includes a step width input region 546 used for inputting the step width. In the step width input region 546, a numerical value representing the interval between points in the depth direction at which the Raman spectrum is acquired at the time of performing the depth measurement can be input. This completes setting of the step width.

After inputting the parameters of the depth range and the step width as described above, the user selects a measurement start key 547 included in the input screen 504. Thus, the depth measurement is started using each set parameter. After the measurement start key 547 is selected, the input screen 504 is hidden until the depth measurement is completed.

The depth measurement can be performed in various modes at the measurement position 511 selected on the surface image of the sample displayed in the surface image display region 501, and any of these modes can be optionally selected by the user. For example, when a plurality of the measurement positions 511 are selected, the depth measurement may be performed from the upper end to the lower end at each measurement position 511, or the depth measurement may be alternately repeated between the measurement position 511 where the depth measurement is performed from the upper end to the lower end and the measurement position 511 where the depth measurement is performed upward from the lower end.

In addition, in the case where the plurality of selected measurement positions 511 are arranged on a straight line, an operation may be repeated, the operation including measuring the same depth at each measurement position 511 by moving the stage 3 on a straight line in the horizontal direction, then moving the stage 3 in the vertical direction, and measuring each measurement position 511 at the depth after movement. In this case, the start point and the end point when the stage 3 is moved in the straight line in the horizontal direction may be at the same position at each depth when viewed in the depth direction, or may be alternately changed at each depth.

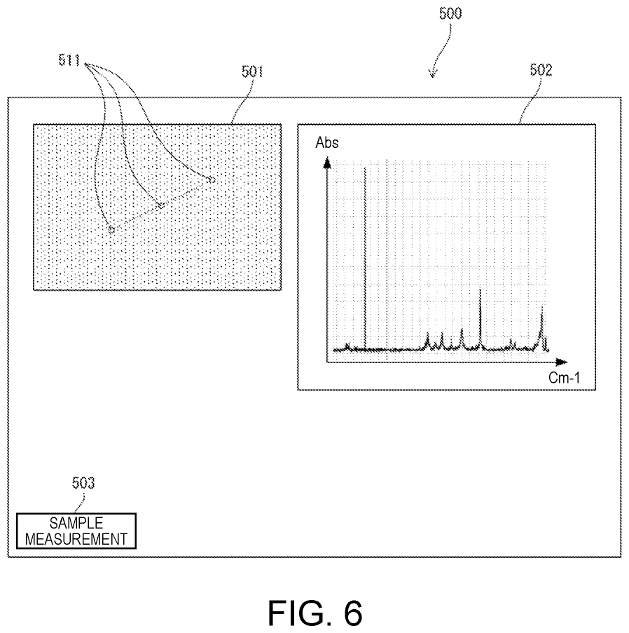

When the depth measurement is completed, the Raman spectrum is displayed in the spectrum display region 502 as shown in FIG. 6. In FIG. 6, the Raman spectrum last acquired in the depth measurement is displayed in the spectrum display region 502.

Note that the user can read a desired Raman spectrum among the plurality of acquired Raman spectra from the storage unit 200 and display the read Raman spectrum on the display unit 300 by operating the operation unit 400. In this case, for example, an operation key such as a bar for selecting the depth position may be displayed on the display unit 300, and the plurality of Raman spectra may be continuously switched and displayed on the display unit 300 by moving the operation key.

### 4. Aspects

It is understood by those skilled in the art that the plurality of exemplary embodiments described above are specific examples of the following aspects.

(Item 1) A Raman microscope according to one aspect is a Raman microscope that acquires a Raman spectrum from a sample on a stage by condensing laser light, irradiating the sample with the laser light, and receiving Raman scattered light from the sample by a detector, the Raman microscope including:

a depth measurement processor that performs depth measurement by changing a focal position of the laser light along a depth direction of the sample which is an irradiation direction of the laser light with respect to the sample, and meanwhile, acquiring the Raman spectrum of the sample at a plurality of points in the depth direction; and

a display processor that displays an input screen used to input a parameter at a time of performing the depth measurement on the sample in association with a surface image of the sample on the stage,

in which the parameter may include a range in which the focal position of the laser light is changed along the depth direction and an interval between the plurality of points within the range.

According to the Raman microscope described in item 1, in the input screen used for inputting the parameters for performing the depth measurement, the range in which the focal position of the laser light is changed along the depth direction and the interval between the plurality of points in the depth direction within the range can be input as parameters. By performing the depth measurement based on the parameters input in this manner, the Raman spectra at the plurality of points in the depth direction can be easily acquired.

(Item 2) In the Raman microscope according to item 1,

the input screen may include a focus operation region operated to change the focal position of the laser light along the depth direction, and an upper end setting region used to set the focal position to an upper end of the range, the focal position being changed by the operation on the focus operation region.

According to the Raman microscope described in Item 2, after the focal position of the laser light is changed along the depth direction by operating the focus operation region, the focal position can be easily set as the upper end of the range in which the focal position of the laser light is changed along the depth direction at the time of depth measurement by the upper end setting region.

(Item 3) In the Raman microscope according to item 2,

the input screen may include a depth input region used to input a depth with respect to the upper end of the range set in the upper end setting region.

According to the Raman microscope described in item 3, by inputting the depth into the depth input region, the depth with respect to the upper end of the range in which the focal position of the laser light is changed along the depth direction at the time of depth measurement is input, and a lower end of the range is set. Therefore, the range can be easily set.

(Item 4) In the Raman microscope according to item 3,

the input screen may include a symbol display region that displays a symbol indicating a relative positional relationship between the upper end and a lower end of the range, and

the display processor may change display of the symbol according to the depth input to the depth input region.

According to the Raman microscope described in item 4, the positions of the upper end and the lower end of the range in which the focal position of the laser light is changed along the depth direction at the time of depth measurement can be displayed to the user in an easy-to-understand manner. Therefore, the range can be more easily set.

(Item 5) In the Raman microscope according to any one of items 2 to 4,

the input screen may include a lower end setting region used to set the focal position to the lower end of the range, the focal position being changed by the operation on the focus operation region.

According to the Raman microscope described in item 5, after the focal position of the laser light is changed along the depth direction by operating the focus operation region, the focal position can be easily set as the lower end of the range in which the focal position of the laser light is changed along the depth direction at the time of depth measurement by the lower end setting region.

What is claimed is:

1. A Raman microscope that acquires a Raman spectrum from a sample on a stage by condensing laser light, irradiating the sample with the laser light, and receiving Raman scattered light from the sample by a detector, the Raman microscope comprising:
a depth measurement processor that performs depth measurement by changing a focal position of the laser light along a depth direction of the sample which is an irradiation direction of the laser light with respect to the sample, and meanwhile, acquiring the Raman spectrum of the sample at a plurality of points in the depth direction; and
a display processor that displays an input screen used to input a parameter at a time of performing the depth measurement on the sample in association with a surface image of the sample on the stage,
wherein the parameter includes a range in which the focal position of the laser light is changed along the depth direction and an interval between the plurality of points within the range.

2. The Raman microscope according to claim 1, wherein the input screen includes a focus operation region operated to change the focal position of the laser light along the depth direction, and an upper end setting region used to set the focal position to an upper end of the range, the focal position being changed by the operation on the focus operation region.

3. The Raman microscope according to claim 2, wherein the input screen includes a depth input region used to input a depth with respect to the upper end of the range set in the upper end setting region.

4. The Raman microscope according to claim 3, wherein
the input screen includes a symbol display region that displays a symbol indicating a relative positional relationship between the upper end and a lower end of the range, and
the display processor changes display of the symbol according to the depth input to the depth input region.

5. The Raman microscope according to claim 2, wherein the input screen includes a lower end setting region used to set the focal position to the lower end of the range, the focal position being changed by the operation on the focus operation region.
